(19) United States
(12) Patent Application Publication
(10) Pub. No.: US 2024/0101316 A1
(43) Pub. Date: Mar. 28, 2024

(54) TOOL STORAGE SYSTEM

(71) Applicant: Techtronic Cordless GP, Anderson, SC (US)

(72) Inventors: J. Porter Whitmire, Greenville, SC (US); J. Luke Jenkins, Williamston, SC (US); Stephen A. Hughett, Anderson, SC (US); Brianna E. Williams, Greenville, SC (US); Tyler H. Knight, Greenville, SC (US); Jeffrey Groves, Greenville, SC (US); Austin Clark, Seneca, SC (US)

(21) Appl. No.: 18/531,042

(22) Filed: Dec. 6, 2023

Related U.S. Application Data
(63) Continuation of application No. 17/483,534, filed on Sep. 23, 2021, now Pat. No. 11,884,456.
(60) Provisional application No. 63/083,551, filed on Sep. 25, 2020.

(51) Int. Cl. B65D 43/16; B25H 3/02; B65D 21/02; B65D 43/22

(52) U.S. Cl. CPC B65D 43/16; B25H 3/02; B25H 3/021; B65D 21/0209; B65D 43/22

(57) ABSTRACT

A storage container system includes rolling toolbox, a storage container, a storage bin, and a storage container assembly. Various aspects relate to a storage container including at least one sidewall extending from a base, the sidewall at least partially defining an outer wall of an interior compartment. A lid is coupled to the sidewall and movable between an open position and a closed position. The interior compartment is accessible while the lid is in the open position, and the interior compartment is covered while the lid is in the closed position.

### CROSS-REFERENCE TO RELATED APPLICATIONS

This application claims priority to co-pending U.S. Provisional Patent Application No. 63/083,551, filed Sep. 25, 2021, the entire contents of which are incorporated herein by reference.

### TECHNICAL FIELD

The present disclosure relates to storage systems, and more particular to storage systems for tools, tool accessories, and the like.

### BACKGROUND

Hand tools, power tools, and associated accessories such as batteries, tool bits, fasteners, and the like, may be moved frequently between a storage space and a work space. One aspect of accessibility is a user's ability to quickly store an object and remove the object from storage. Another aspect of accessibility is the storage system's ability to engage many differently sized containers with a standardized connection mechanism between the system and the container. This may also permit an object or container to engage the storage system at a plurality of locations. Finally, storage systems are accessible when located adjacent a work space.

### SUMMARY

In one independent aspect, a rolling toolbox includes: a container including a base, a plurality of sidewalls, a lid coupled to one of the sidewalls, and a latch, the lid movable between a closed portion and an open position, the latch selectively securing the lid in the closed position, the lid including a feature configured to engage a complementary feature positioned on the base of another container and releasably secured to the other container in a stacked relationship, at least one of the container and the other container includes a locking member that is slidable between an engaged position in which the locking member secures the base of the other container to the lid and a disengaged position in which the other container is removable from the lid; a wheel rotatably coupled to the container and supporting the container for movement on a support surface; and a handle coupled to the container to guide movement of the container, the handle being movable between a retracted position and an extended position.

In another independent aspect, a storage container includes: a base; at least one sidewall extending from the base, the sidewall at least partially defining an outer wall of an interior compartment; a lid coupled to the sidewall and movable between an open position and a closed position, the interior compartment being accessible while the lid is in the open position, the interior compartment being covered while the lid is in the closed position; and an elastic support coupled to at least one of the base, the sidewall, and the lid, the elastic support being expandable to receive an item between the elastic support and the at least one of the base, the sidewall, or the lid and exert a compressive retaining force on the item.

In yet another independent aspect, a storage container assembly include: a container including a base, at least one sidewall extending from the base and at least partially defining an outer wall of an interior compartment, and a lid coupled to the sidewall and movable between an open position and a closed position, the interior compartment being accessible while the lid is in the open position, the interior compartment being covered while the lid is in the closed position, the container including a first connection feature and a second connection feature; and a storage bin including a compartment and a mating feature, the container being selectively mountable in a first configuration in which the mating feature engages the first connection feature and a second configuration in which the mating feature engages the second connection feature.

In still another independent aspect, a storage container includes: a base; a plurality of sidewalls extending from the base and defining an outer wall of an interior compartment, a first sidewall joined to a second sidewall at a corner portion; a lid coupled to the sidewalls and movable between an open position and a closed position, the interior compartment being accessible while the lid is in the open position, the interior compartment being covered while the lid is in the closed position; and a latch movable between an engaged position in which the lid is secured relative to the second sidewall and a disengaged position in which the lid is unsecured relative to the second sidewall, the latch positioned adjacent the corner portion and oriented at an acute angle relative to each of the first sidewall and the second sidewall.

Other aspects of the disclosure will become apparent by consideration of the detailed description and accompanying drawings.

### BRIEF DESCRIPTION OF THE DRAWINGS

FIG. 1 is a perspective view of a rolling toolbox supporting multiple storage containers.

FIG. 2 is a perspective view of the rolling toolbox of FIG. 1.

FIG. 3 is another perspective view of another embodiment of a rolling toolbox with a handle in a retracted position.

FIG. 4 is another perspective view of the rolling toolbox of FIG. 3 with the handle in an extended position.

FIG. 5 is another perspective view of the rolling toolbox of FIG. 3 with a handle locking mechanism.

FIG. 6 is another perspective view of the rolling toolbox of FIG. 3 with the handle locking mechanism in an unlocked position.

FIG. 7 is a perspective view of a rolling toolbox according to another embodiment, with a handle in a retracted position.

FIG. 8 is a perspective view of the rolling toolbox of FIG. 7 with the handle in an extended position.

FIG. 9 is a perspective view of a spring plunger mechanism of the rolling toolbox of FIG. 7.

FIG. 10 is a cross-sectional view of the spring plunger mechanism of FIG. 9 with the handle in a locked position.

FIG. 11 is another cross-sectional view of the spring plunger mechanism of FIG. 9 with the handle in an unlocked position.

FIG. 12 is a perspective view of a rolling toolbox according to another embodiment, with a handle in an extended position.

FIG. 13 is another perspective view of the rolling toolbox of FIG. 12 with a handle closure mechanism in a locked position.

FIG. 14 is a front perspective view of the rolling toolbox of FIG. 3 including a front hook.

FIG. 15 is a rear perspective view of the rolling toolbox of FIG. 3 including a rear hook and a treaded foot plate.

FIGS. 16A-16D are perspective views of a container including bins.

FIG. 16E is a cross-sectional view through the container and one of the bins of FIG. 16A.

FIG. 17 is a perspective view of a container in an open position with multiple bins provided therein.

FIG. 18A is another perspective view of a container in an open position with an elastic loop mechanism provided therein.

FIG. 18B is a perspective view of a container in an open position with multiple quarter length bins provided therein.

FIG. 18C is a perspective view of a container in an open position with multiple third width bins provided therein.

FIG. 18D is a perspective view of a container in an open position with bins supported on a peripheral edge of a sidewall within and along the exterior of a container.

FIG. 19 is a perspective view of a bit container configured to engage a container.

FIG. 19A is a perspective view of the bit container of FIG. 19 in an open position.

FIG. 19B is a front view of the bit container of FIG. 19 engaged with a wall storage system.

FIG. 19C is a perspective view of the bit container of FIG. 19 engaged on the exterior of a container.

FIG. 19D is a perspective view of the bit container of FIG. 19 engaged in the interior of a container.

FIG. 20 is another perspective view of a container in the open position.

FIG. 21 is a perspective view of bins configured for storage within the container of FIG. 20.

FIG. 22 is a perspective view of the bins of FIG. 21 positioned within a container.

FIG. 23 is another perspective view of the container of FIG. 22 including bins therein.

FIG. 24 is a perspective view of the bins of FIG. 23 supported on a wall storage system.

FIGS. 25A-25E are perspective view of various configurations of bins provided within a container.

FIG. 26 is a perspective view of a container provided with a lid having a locking bit bar in a closed position.

FIG. 27 is a perspective view of the container of FIG. 26 with the locking bit bar in an open position.

FIG. 28 is a perspective view of a container according to another embodiment and in an open position.

FIG. 29 is a perspective view of the container of FIG. 28 in a closed position.

FIG. 30 is a top view of the container of FIG. 28 adjacent another container of FIG. 28 and with a toggle latch of one of the containers in an unlocked position.

FIG. 31A is a cross-sectional view of the rolling toolbox with a latching mechanism of an upper storage container in an engaged position with a lower storage container.

FIG. 31B is a cross-sectional view of the rolling toolbox with the latching mechanism of the upper storage container in a disengaged position with the lower storage container.

### DETAILED DESCRIPTION

Before any aspects are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, whether direct or indirect.

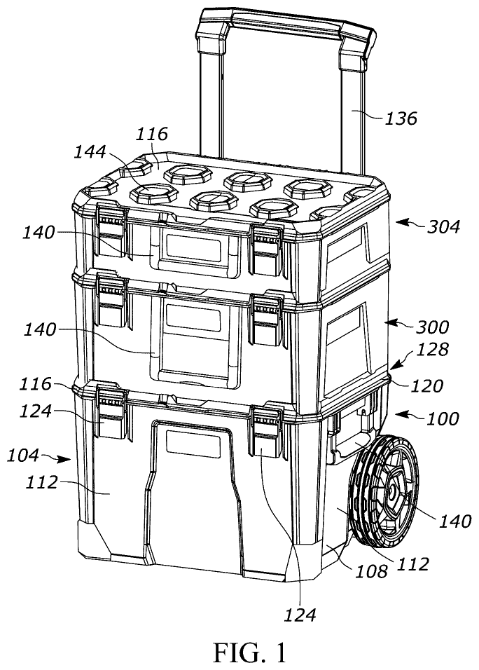

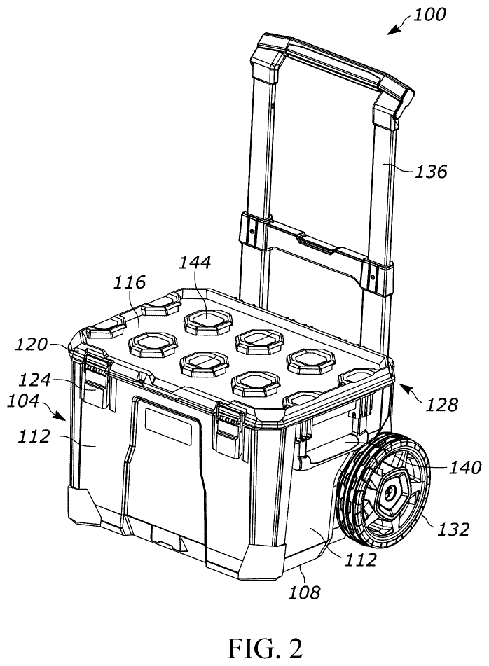

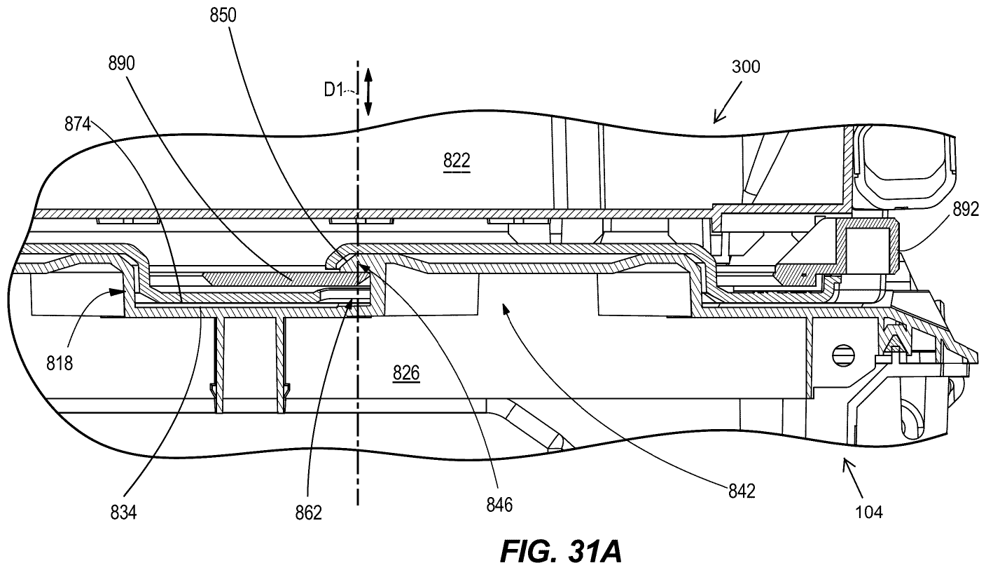

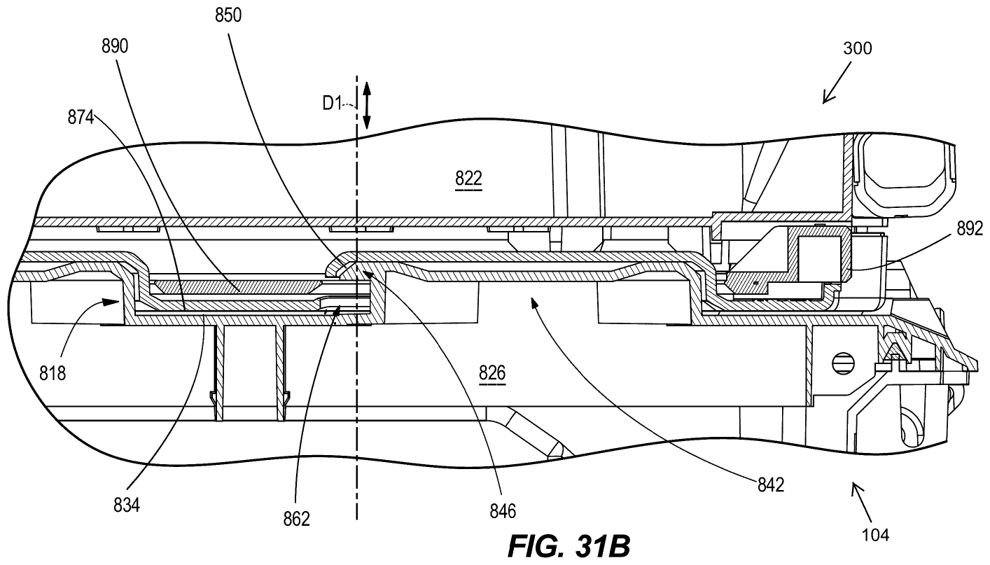

FIGS. 1 and 2 illustrate a rolling storage container (e.g., toolbox 100). As illustrated in FIG. 1, the rolling toolbox 100 may be part of a tool storage system, and an upper surface (e.g., the lid) of the toolbox 100 may include an interface for receiving one or more stacked containers 104, 300, 304. Each container 104, 300, 304 may include at least one feature for mating the container 104, 300, 304 to an adjacent container 104, 300, 304. Some exemplary mating features for the container 104, 300, 304 are disclosed in U.S. patent application Ser. No. 17/153,251, filed Jan. 20, 2021. The entire contents of these applications are incorporated by reference herein. One example of such a mating feature for securing a container 104, 300, 304 to another container 104, 300, 304 for use in the rolling toolbox 100 is described below with regards to FIGS. 31A-31B and includes a latching mechanism. As illustrated in FIG. 2, the rolling toolbox 100 may include a single container 104 having a base 108 and a plurality of sidewalls 112 extending from the base 108. In the illustrated embodiment, the base 108 is generally planar and four sidewalls 112 each extend in a direction perpendicular to the base 108 forming a cubic profile, or a substantially cubic profile. Other configurations of the container 104 are possible. The rolling toolbox 100 further includes a lid 116 which is coupled to the sidewalls 112. As shown in FIG. 2, the lid 116 includes a periphery 120 which projects from the lid 116. As shown in FIG. 1, the periphery 120 may be dimensioned to engage another container on top of container 104.

The container 104 includes a latch 124 configured to secure the lid 116 to the sidewall 112. Each container 104 further includes a hinge coupling 128 between one of the sidewalls 112 and the lid 116. The hinge coupling 128 permits the lid 116 to pivot relative to the sidewall 112. The latch 124 is movable between an engaged position in which the latch 124 secures the lid 116 to the sidewall 112 and an open position in which the latch 124 is removed from the lid 116 and the lid 116 is movable relative to the sidewalls 112. In the illustrated embodiment, each container 104 includes at least two latches 124. The latches 124 are spaced from each other along the sidewall 112 such that load in securing the lid 116 to the sidewall 112 is distributed between the two latches 124. The latch 124 may be a draw latch, a latch-style toggle clamp, or the like. The latch 124 may engage the periphery 120 to hold the lid 116 against the sidewalls 112. The latches 124 may be provided on a sidewall 112 opposite the hinge coupling 128.

The rolling toolbox 100 includes wheels 132 which are rotatably coupled to the container 104. In the illustrated embodiment of FIG. 1, the container 104 that supports the other containers 300, 304 is provided with the wheels 132. The wheels 132 permit the container 104 and the rolling toolbox 100 (i.e., the container 104 along with the containers 300, 304) to be moved from a storage location (i.e., a first location) to a work site (i.e., a second location). As such, the toolbox 100 is a rolling toolbox 100 that may roll forwards and/or rearwards.

As illustrated in FIG. 1, the rolling toolbox 100 includes a handle 136. The handle 136 may be secured to the container 104 as shown in FIG. 2. The handle 136 may extend above the sidewalls 112 such that a user can pull upon the handle 136 while the container 104 is translated upon the ground by the wheels 132. Each container 104 may be provided with an auxiliary handle 140. In the illustrated embodiment, the auxiliary handles 140 of the containers 300, 304 are provided on the sidewall 112 which engages the latch 124 (i.e., a sidewall 122 opposite the hinge coupling 128). In the illustrated embodiment, the auxiliary handle 140 of the container 104 is provided on a sidewall 112 that does not engage the latch 124. In the illustrated embodiment, opposing sidewalls 112 are provided with auxiliary handles 140 such that a user may grasp two auxiliary handles 140 on opposite sides of the container 104. The auxiliary handles 140 each may be pivotable relative to the sidewalls 112. Other arrangements of the auxiliary handle 140 are possible. Accordingly, the user may grasp the handle 136 while translating the rolling toolbox 100 along the ground by the wheels 132 from a storage space to a position adjacent the work space, and the user may carry the container 104 by grasping the auxiliary handle 140. Finally, in the illustrated embodiment, the exterior surface of the lid 116 is provided with a plurality of protrusions (e.g., cleats 144). The cleats 144 are described in detail below, and generally function as hooks to secure other parts (e.g., bins 286, 320, 348, 376, 380 as well as other parts such as hand tool holders, power tool holders, power tools, sporting good holders, etc.) to the rolling toolbox 100.

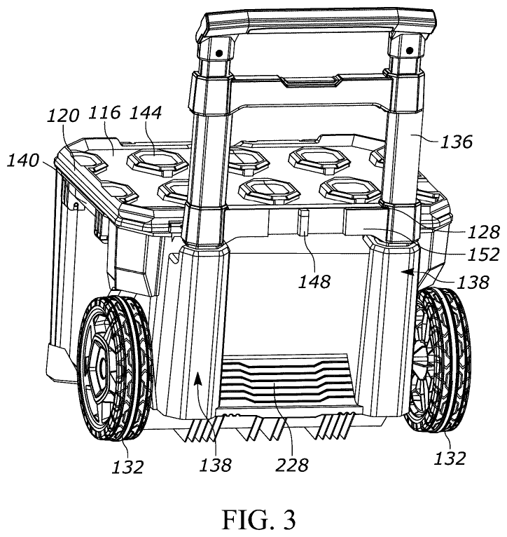

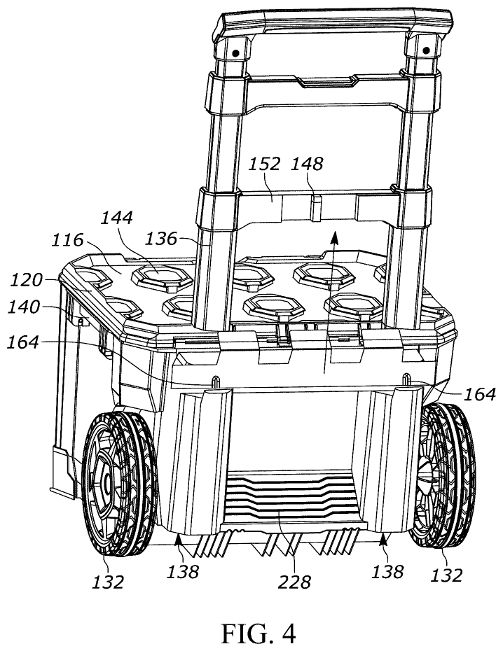

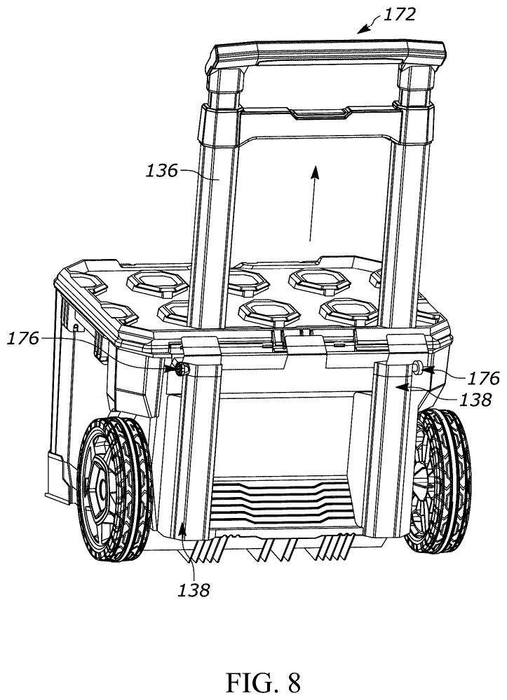

As described below, the handle 136 is a telescopic handle 136. In the illustrated embodiments, the handle 136 is generally U-shaped, with arms of the “U” being received in the receptacle 138. In the illustrated embodiments, the container 104 includes two receptacles 138 which each receive one of the arms of the “U”. The handle 136 may be locked in a desired position by any one of a plurality of connection mechanisms which are described below and illustrated in FIGS. 3-6, FIGS. 7-11, FIGS. 12-13, respectively. In each of these connection mechanisms, the handle 136 is capable of being telescoped between a retracted position (e.g., FIG. 3) and a deployed position (e.g., FIG. 4). The handle 136 can then be secured in the desired position by the connection mechanism. Other connection mechanisms may be used to secure the handle 136 to the sidewalls 112. In the retracted position (FIG. 3), at least a portion of the handle 136 is received in a corresponding receptacle 138 of the container 104. The receptacle 138 extends generally perpendicularly away from the base 108. In the illustrated embodiment, the receptacle 138 is adjacent the sidewall 112 which is provided with the hinge coupling 128. In the deployed position (FIG. 4), the handle 136 is translated to a location further from the base 108 than in the retracted position (FIG. 3). In the illustrated embodiments, the handle 136 may be either infinitely translatable between the deployed position and the retracted position or the handle 136 may be translatable to discrete positions between the deployed position and the retracted position. The handle 136 and the receptacle 138 may be dimensioned such that the handle 136 is not removable from the receptacle 138 upon intended translation to the deployed position.

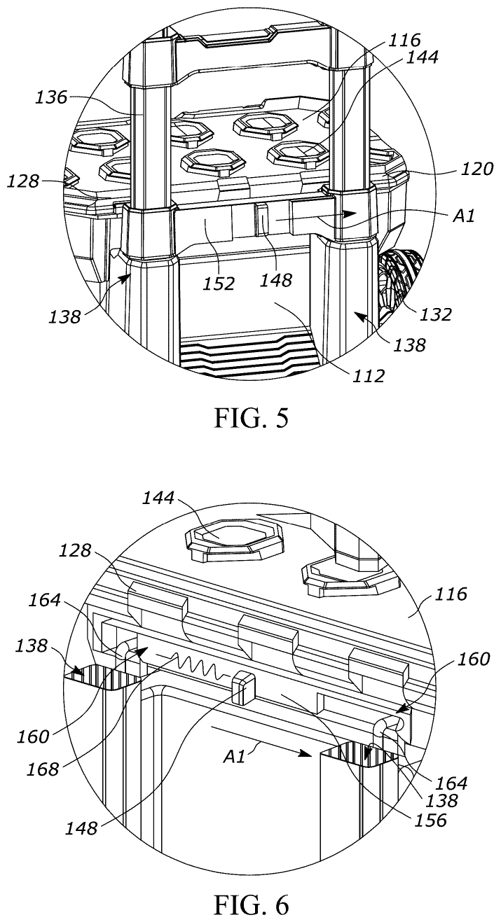

FIGS. 3-6 illustrate a first embodiment of a lock device configured to secure the handle 136 at a desired position relative to the receptacle 138. The first embodiment of the lock device includes an actuator 148 which is located at a central position along a cover 152 (FIG. 3). The actuator 148 projects beyond the bounds of the cover 152 such that a user may manipulate the actuator 148 from exterior to the cover 152. The cover 152 includes a latch bar 156 therein. The latch bar 156 includes a latch hook 160. The container 104 is provided with a latch catch 164 coupled to the sidewall 112. The latch catch 164 may be coupled to the same sidewall 112 that engages the hinge coupling 128 and adjacent the handle 136. Further, the latch catch 164 may be located adjacent the receptacles 138. The latch bar 156 is movable in directions parallel to the arrow A1. As illustrated in FIG. 6, a user may manipulate the actuator 148 to translate the latch bar 156 along the cover 152 and along the arrow A1 to a position in which the latch hook 160 is misaligned with the latch catch 164. Further, as illustrated in FIG. 6, the first embodiment of the connection mechanism may include a spring 168 configured to bias the latch bar 156 in a direction opposite the arrow A1 such that the latch hook 160 is engaged with the latch catch 164. FIG. 5 illustrates the handle 136 retracted into the receptacle 138 prior to actuation of the actuator 148 against the bias of the spring 168. The latch bar 156 is movable between a locked position in which the latch bar is locked to the latch catch 164 (FIG. 5) and a released position (FIG. 6) in which the latch bar 156 is removed from the latch catch 164. In the released position, the handle 136 is translatable along the receptacle 138 to the deployed position (FIG. 4). As illustrated in FIG. 4, the cover 152 may be fixed relative to the handle 136 such that the latch bar 156 is used to secure the handle 136 in the retracted position (FIG. 3) with the cover 152 adjacent the receptacle 138.

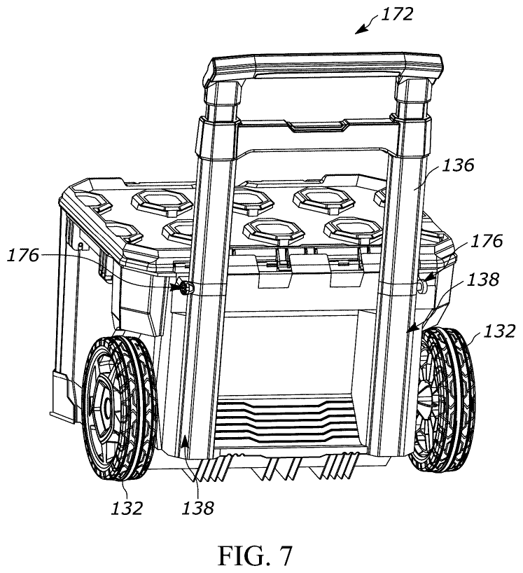

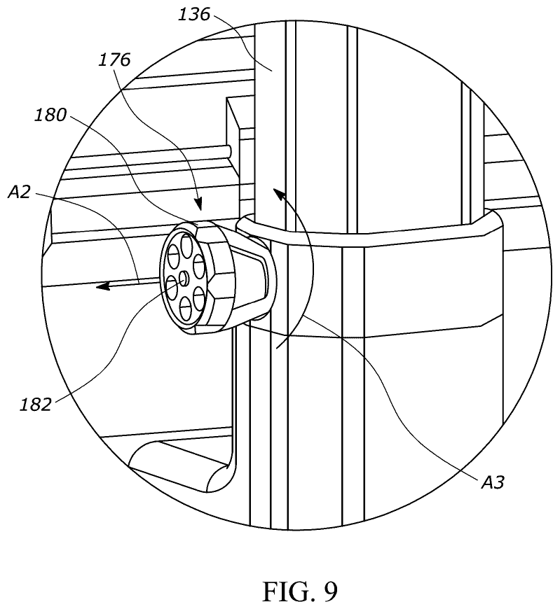

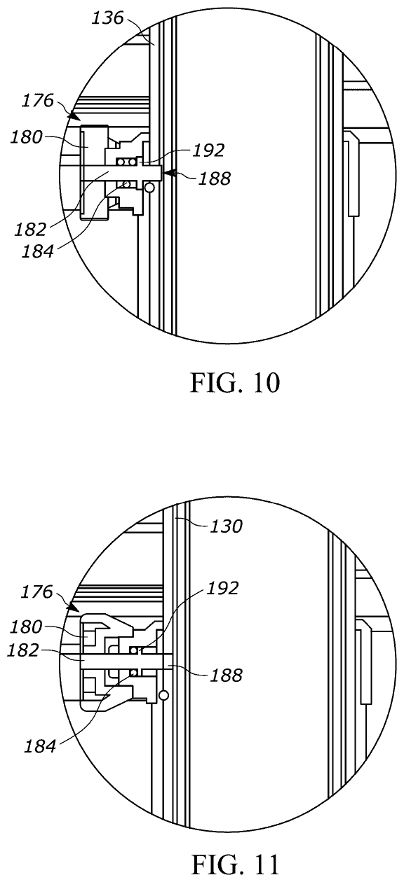

FIGS. 7-11 illustrate a second embodiment of the connection mechanism (i.e., a rolling toolbox 172 including a spring plunger mechanism 176) configured to secure the handle 136 at a desired position relative to the receptacle 138. The spring plunger mechanism 176 includes a knob 180, a plunger 182 coupled to the knob 180, and a spring 184 which biases the plunger 182 against the handle 136. The handle 136 in the second embodiment of the connection mechanism includes a through hole 188. Optionally, the handle 136 may include a plurality of holes 188 corresponding to different projection distances of the handle 136 extending from the receptacle 138. The knob 180 is dimensioned such that at some radial positions of the knob 180, the plunger 182 may be translated to a position (FIG. 10) within the hole 188. The plunger 182 may be retracted from the hole 188 (FIG. 11) to permit removal of the handle 136 from the receptacle 138. The container 104 can then be used without the handle 136. As shown in FIGS. 10 and 11, the plunger 182 includes a shoulder 192 which abuts the spring 184. The other end of the spring 184 is adjacent the knob 180 such that a user must provide force to overcome the bias of the spring to move the knob 180 in a direction of the arrow A2 in FIG. 9. Once the knob 180 is translated with the plunger 182 retracted from the hole 188, the knob 180 can then be rotated along or in the opposite direction of arrow A3. The knob 180 can then hold the plunger 182 in the retracted position away from the hole 188 (FIG. 11). In sum, the knob 180 is movable between a locked position (FIG. 10) in which the plunger 182 is received in the hole 188 and a released position (FIG. 11 in which the plunger 182 is removed from the hole 188.

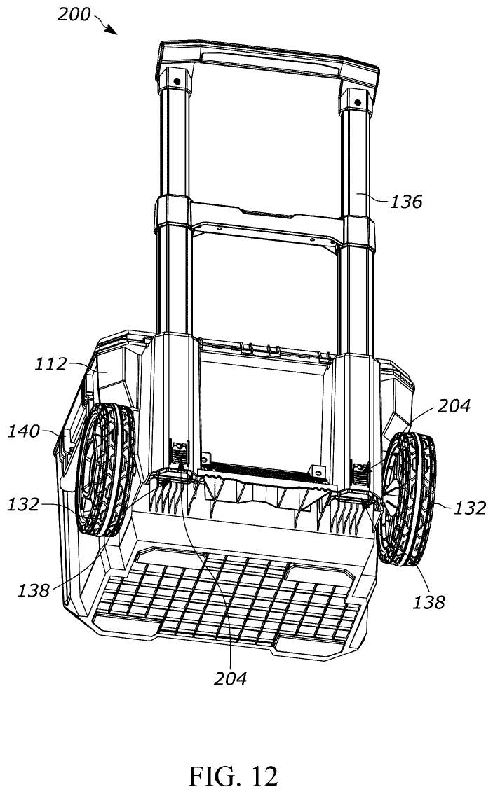

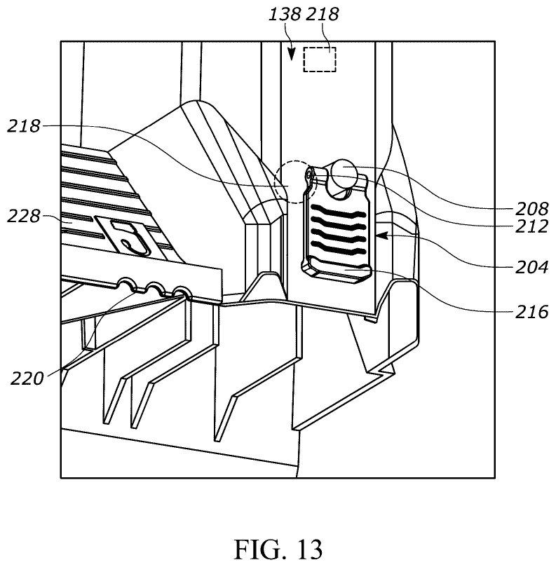

FIGS. 12-13 illustrate a third embodiment of the connection mechanism (i.e., a rolling toolbox 200 including a locking pin mechanism 204) configured to secure the handle 136 at a desired position relative to the receptacle 138. The rolling toolbox 200 may include like features when compared to the rolling toolbox 100. The locking pin mechanism 204 includes a locking pin 208 and a pivot pin 212 that is received by the locking pin 208 and is coupled to an actuator 216. In the illustrated embodiment, the actuator 216 is a flap which is coupled with the pivot pin 212 extending through one end of the flap. The handle 136 includes a mating element 218. The mating element 218 is located within the receptacle 138 when the handle 136 is in the retracted position. In the illustrated embodiment, when the handle is in the retracted position, the mating element 218 may be located adjacent the base 108. The locking pin 208 is movable in response to movement of the actuator 216. The actuator 216 is movable between a locked position (FIG. 13) in which the locking pin 208 is secured to the mating element 218 and a released position in which the locking pin 208 is removed from the mating element 218, and the handle 136 freely translates along the receptacle 138. The locking pin 208 may pass through the sidewall 112 and into the receptacle 138. In other embodiments, other such connection mechanisms may secure the handle 136 to the sidewalls 112 via the receptacles 138 in a telescopic relationship.

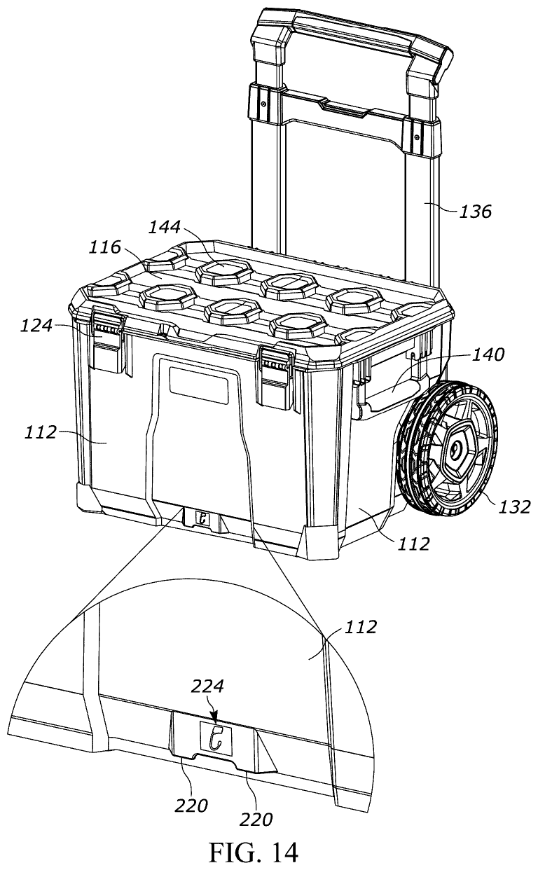

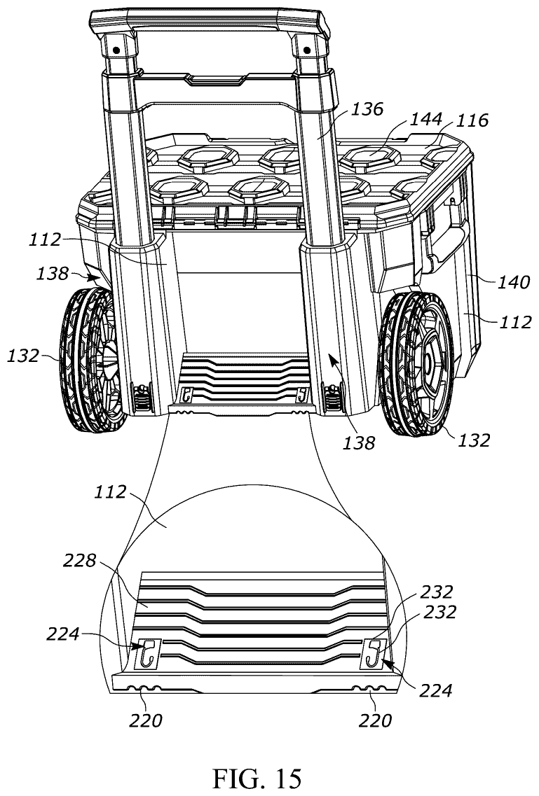

FIGS. 14 and 15 illustrate front perspective and rear perspective views of the rolling toolbox 100, respectively. As illustrated in FIG. 14, the sidewall 112 that engages the latches 124 (i.e., a first sidewall or a “front sidewall”) is further provided with hooks 220 adjacent the base 108. The sidewall 112 may further be provided with indicia 224 to indicate the location of the hooks 220. As illustrated in FIG. 15, the sidewall 112 adjacent the hinge coupling 128 (and closest to the wheels 132) (i.e., a second sidewall or a “rear sidewall”) is also provided with hooks 220. The hooks 220 adjacent the rear sidewall may be further spaced apart from each other than the hooks 220 provided adjacent the front sidewall. In other embodiments, the front sidewall and the rear sidewall may be provided with a different (i.e., 1, 3, or more) number of hooks 220 which may be otherwise arranged along the sidewalls 112. With continued reference to FIG. 15, the rear sidewall 112 is further provided with indicia 224 to indicate the location of the hooks 220. Finally, with continued reference to FIG. 15, the rear sidewall 112 is further provided with a foot plate 228. The foot plate 228 is angled relative to the sidewall 112. The hooks 220 and the indicia 224 may be provided upon the foot plate 228. The foot plate 228 may optionally include treads 232. The treads 232 may be depressions extending along a length of the foot plate 228. The treads 232 may be otherwise shaped.

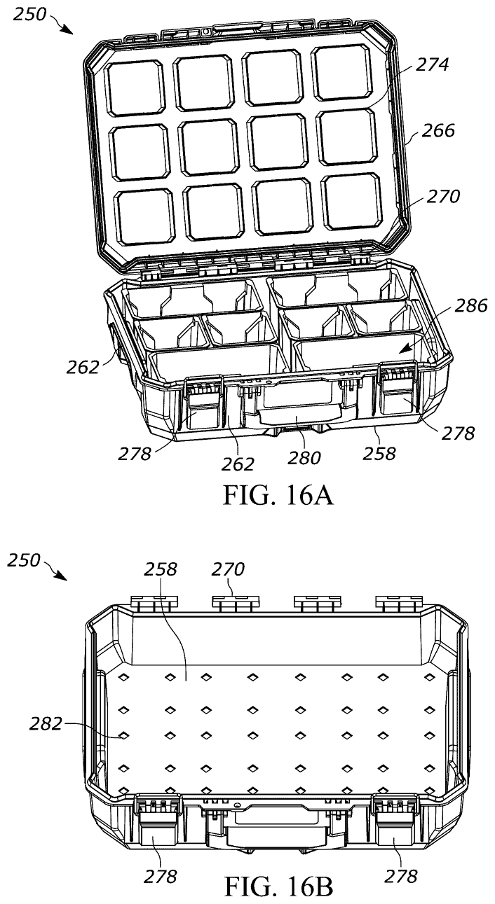

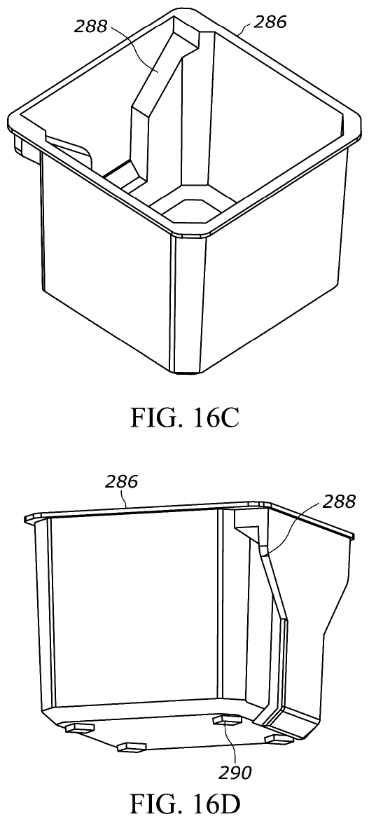

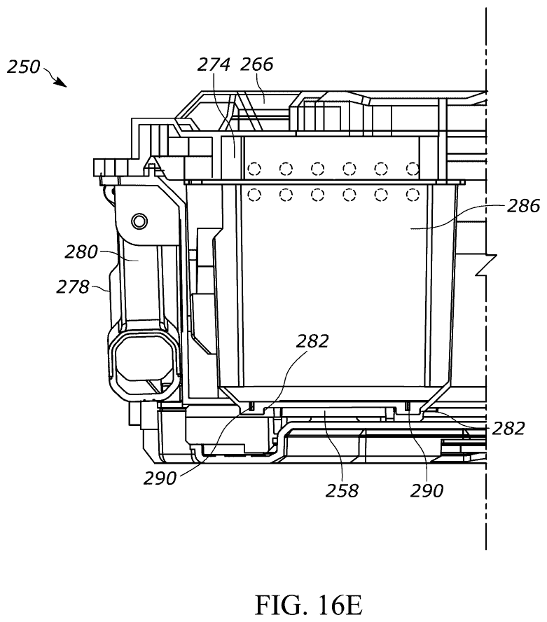

FIGS. 16A-27 illustrate various aspects of bins for a container storage system. As will be described below for each embodiment, the bin may be coupled to the container. The bins may be secured to the container at a variety of locations, and each bin may further be provided with features to secure the bin to another structure such as the cleat 144.

FIGS. 16A-16E illustrate a container 250 (e.g., a container that is stackable on/over a second, adjacent container 250, on/over the rolling toolbox 100, and/or the like). The container 250 may be configured to receive bins 286 therein. Similar to the container 104, 300, 304, the container 250 may include a base 258 and a plurality of sidewalls 262 extending from the base 258. The container 250 also includes a lid 266 hingedly coupled to one of the sidewalls 262 by a hinge coupling 270. A surface of the lid 266 may be provided with protrusions 274. In the illustrated embodiment, the protrusions 274 are provided on an interior surface of the lid 266 that faces the base 258 when the lid 266 is closed. The protrusions 274 are dimensioned to correspond with the sizes of the bins 286.

As illustrated in FIG. 16E, when the lid 266 is closed, the protrusions 274 may be seated within an upper surface of an associated one of the bins 286. Accordingly, the upper edge of the bin 286 may be a mating feature configured to engage the protrusions. A first protrusion 274 may engage the upper surface of the bin 286, and that same bin 286 may be moved to engage another protrusion 274 with the bin 286 in a different position within the container 250. Optionally, an o-ring, gasket, and/or other sealing member or material (not shown) may be provided between the upper surface of the bin 286 and the protrusion 274 to seal the contents of the bin 286 from the remainder of the interior of the container 250. With reference to FIG. 16A, the container 250 may similarly include latches 278 to close the lid 266 relative to the sidewalls 262. The container 250 may include an auxiliary handle 280 similar to the auxiliary handles 140 of the containers 104, 300, 304.

As illustrated in FIG. 16B-16E, the base 258 may be further provided with a plurality of recesses 282, and the bin 286 is provided with at least one foot 290. In the illustrated embodiment, the recesses 282 are arranged in a rectangular array upon the base 258. In the illustrated embodiment, as shown in FIG. 16D, the bin 286 includes four feet 290 each provided at a corner of the bin 286. With continued reference to FIG. 16D, the bin 286 may be provided with a cleat interface 288 at an exterior surface thereof. With reference to FIG. 16C, the bin 286 may further be provided with a cleat interface 288 at an interior and/or exterior surface thereof. As illustrated in FIG. 16E, the at least one foot 290 is secured within the recesses 282 when the bin 286 is positioned within the container 250 (and optionally, when the lid 266 is closed). In the illustrated embodiment, the rectangular array includes longitudinal and lateral spacing between each of the recesses 282 such that each of the four feet 290 corresponding to the four corners of the bin 286 may be received within one of the recesses 282. Optionally, the recesses 282 may be dimensioned marginally smaller than the feet 290 such that the feet 290 are press-fit into the recesses 282. As illustrated in FIG. 16A, the bins 286 may have different sizes. Some of the bins 286 may have a width that is twice as wide as other bins 286.

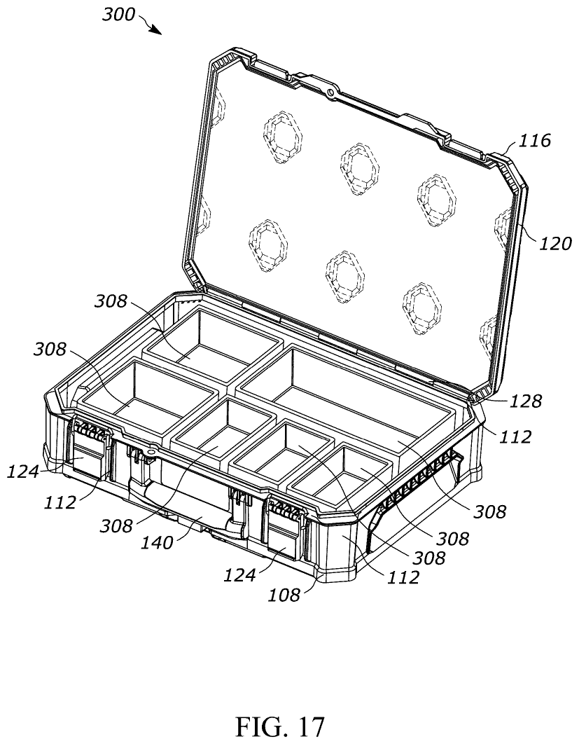

FIG. 17 illustrates the internal compartment of container 300. The container 300 includes like features of the container 104. The container 300 may be dimensioned to secure many variously sized bins 308 therein.

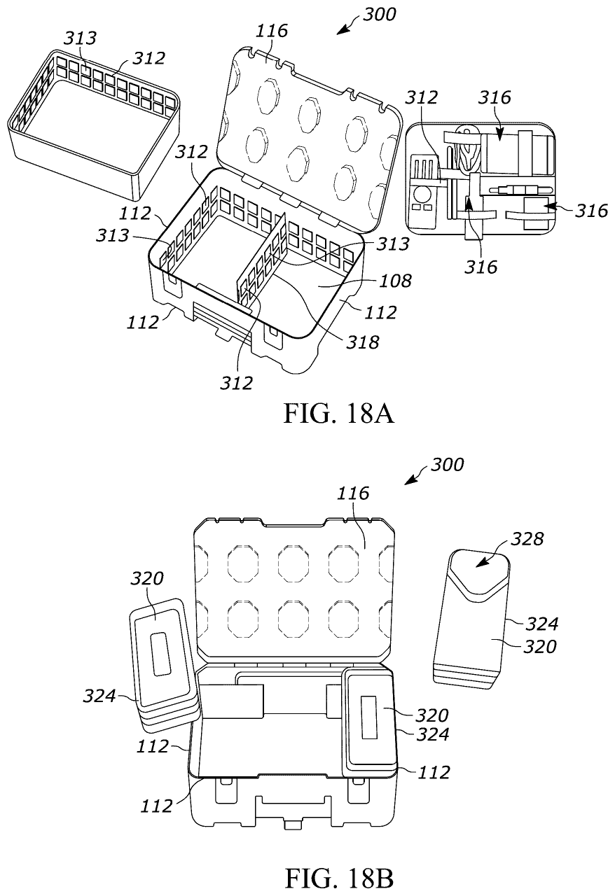

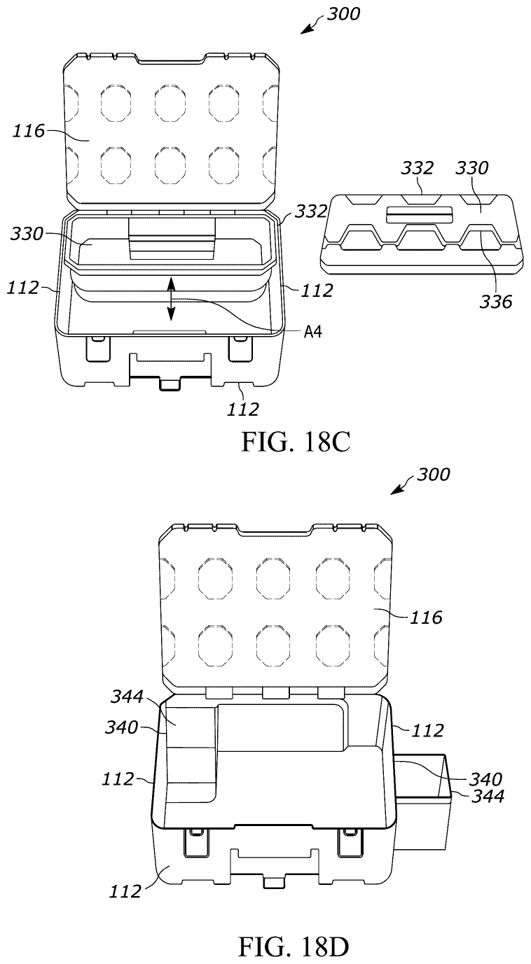

FIGS. 18A-18D illustrate different uses of the container 300. As illustrated in FIG. 18A, the sidewalls 112 of the container 300 may be provided with an elastic band structure 312. The elastic band structure 312 is configured to deflect (i.e., the elastic band structure 312 is expandable) to secure (i.e., receive) an item 316 between the elastic band structure 312 and at least one of the base 108, the sidewall 112, or the lid 116 for retaining the item 316. The elastic band structure 312 may also be provided on a divider wall 318. The elastic band structure 312 is coupled to at least one of the base 108, the sidewall 112, the lid 116, or the divider wall 318. The elastic band structure 312 may be coupled to the at least one of the base 108, the sidewall 112, the lid 116, or the divider wall 318, for example, by being stitched to an inner surface thereof, being retained via ridges, lips, grooves, or other mechanical retainers, or by being glued to the interior surface thereof. In some embodiments, the elastic band structure 312 may be coupled to an intermediate surface which is coupled to the at least one of the base 108, the sidewall 112, the lid 116, or the divider wall 318. Other mechanisms may couple the elastic band structure 312 to at least one of the sidewall 112, the lid 116, or the divider wall 318. The divider wall 318 may be configured to be attached within the interior of the container 300. In the illustrated embodiment, the divider wall 318 extends in a direction extending away from the base 108 and generally parallel to two of the sidewalls 112. The elastic band structure 312 may be an array of elastic straps 313 (e.g., a MOLLE loop array). In some embodiments, the array of elastic straps 313 includes variable strap width between each of the elastic straps 313. In some embodiments, the array of elastic straps 313 includes a variable weave pattern between each of the elastic straps 313. The elastic band structure 312 (and/or array of elastic straps 313) may be provided with at least one traction element (not shown) provided on a surface thereof, the traction element having a different coefficient of friction than the elastic band such that an amount of contact friction between the item 316 and the traction element is enhanced. In some embodiments, the traction element may be a rubber traction dot provided on an exterior surface of at least one of the elastic straps 313 of the elastic band structure 312. The traction dot may not necessarily enclose the entirety of the elastic strap 313 therein. However, the traction dot may weave in and out of the elastic strap 313 intermittently. Other such traction elements are possible.

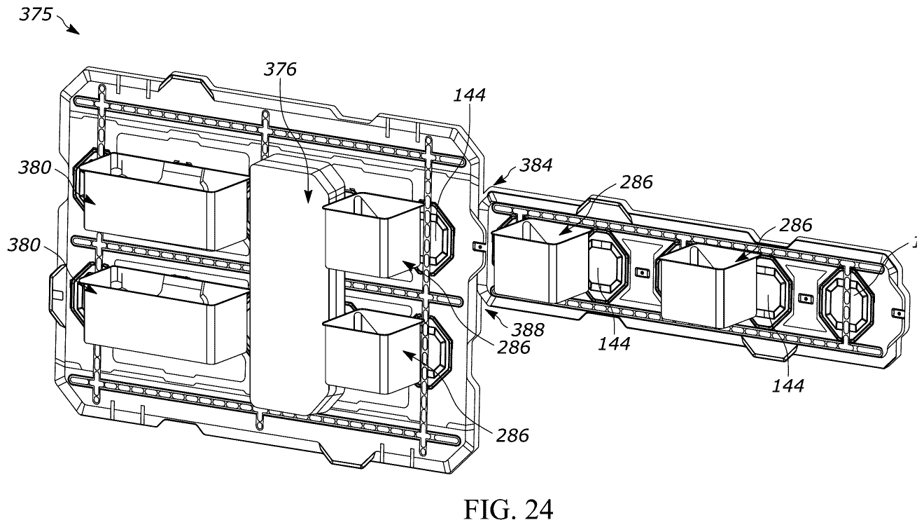

FIG. 18B illustrates another bin 320 configured for use with the container 300. The bin 320 includes a hook 324 provided at a peripheral wall thereof. The hook 320 is configured to engage a top surface of the sidewall 112 with at least a portion of the bin 320 being received within the container 300. The bin 320 may further be provided with a cleat interface 328 which may engage the cleat 144 in a similar fashion to the cleat interfaces 288 of the bin 286 (FIGS. 16C, 16D, 24). A bin 330 illustrated in FIG. 18C also has a periphery with a hook 332. Additionally, the bin 330 also has a cleat interface 336. The bin 330 may be an accessory tray configured to slide in a direction parallel to arrow A4 with the hook 332 while being supported upon the sidewalls 112 between various positions (i.e., along the sidewalls 112 between a first position and a second position). Finally, FIG. 18D illustrates accessory bins 344 with hooks 340 which function similar to the hooks 324 and the hooks 332. The accessory bins 344 may be positioned with the hooks 340 engaging the sidewalls 112 and with at least a portion of the accessory bin 344 within the interior of the container 300. Alternatively, the accessory bins 344 may be positioned with the hooks 340 engaging the sidewalls 112 and with at least a portion of the accessory bin 344 being exterior to the bin 300. In each of these embodiments, the hooks 324, 332, 344 may be configured as a “mating feature,” and an upper portion of the sidewall 112 may be configured as a “connection feature.” The upper portion of the sidewall 112 includes the entire perimeter of the sidewalls 112, as the hooks 324, 332, 344 can engage each of the sidewalls 112 equally.

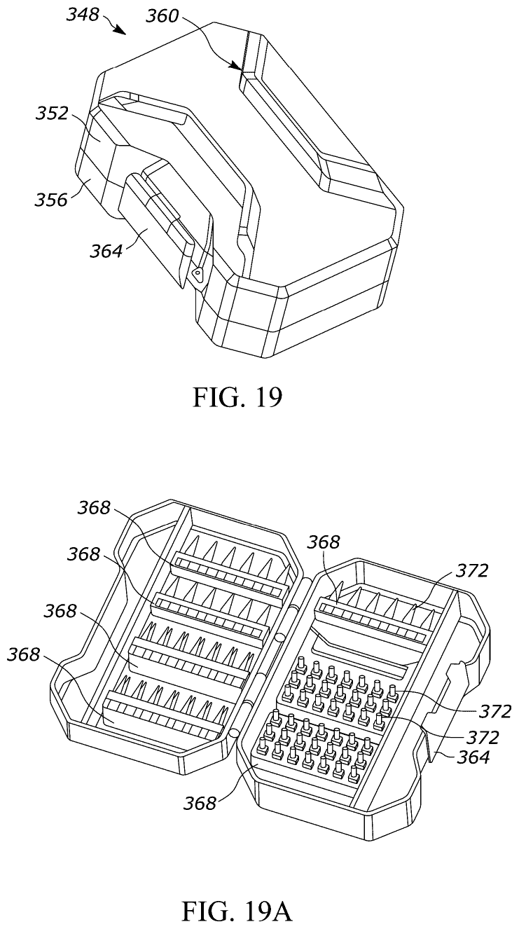

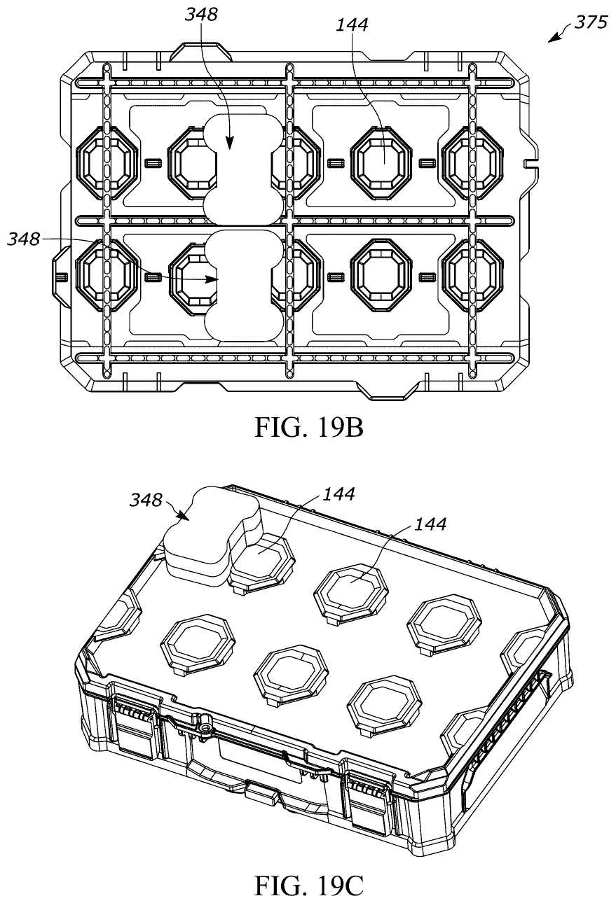

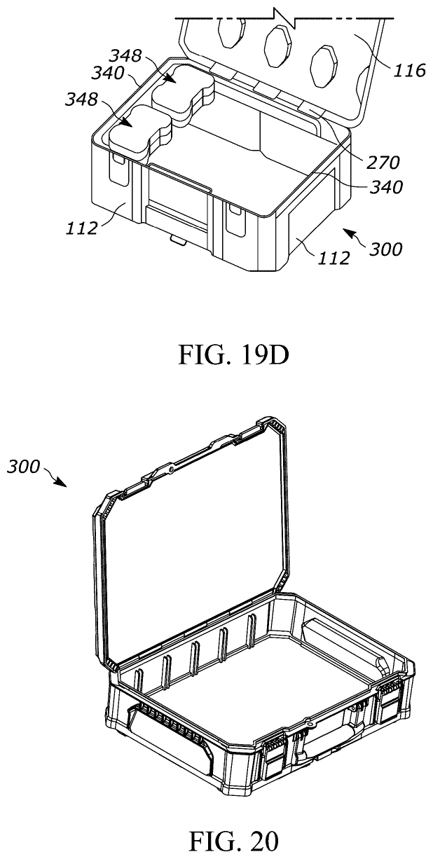

FIGS. 19 and FIGS. 19A-19D illustrate a bin 348 in the form of a bit holder 348. As illustrated in FIG. 19, the bit holder 348 includes a first clamshell housing 352 and an opposing second clamshell housing 356. At least one of the clamshell housings 352, 356 (as illustrated in FIG. 19, the clamshell housing 352) is provided with a cleat interface 360 dimensioned to engage the cleat 144. The bit holder 348 further includes a latch 364 to hold the clamshell housings 352, 356 in a closed position (FIG. 19). FIG. 19A illustrates the bit holder 348 in an open position. The bit holder 348 may receive, within the clamshell housings 352, 356, a bit receiver 368. In the illustrated embodiment, the bit holder 348 receives a plurality of bit receivers 368. Each bit receiver 368 may receive a plurality of bits 372 therein for storage within the bit holder 348. As illustrated in FIG. 19B, the bit holder 348 may engage at least one cleat 144 of a wall panel 375. The wall panel 375 includes a plurality of cleats 144 arranged thereon. The cleats 144 may be spaced on the wall panel 375 in a rectangular array. Similarly, as illustrated in FIG. 19C, the bit holder 348 may engage cleats 144 provided on an exterior surface of the lid 166. Additionally, as illustrated in FIG. 19D, the cleat interface 360 may be configured to mount the bit holder 348 within the container 300 with the cleat interface 360 functioning as the aforementioned hooks 324, 332, 344 which engage a top surface of the sidewalls 112.

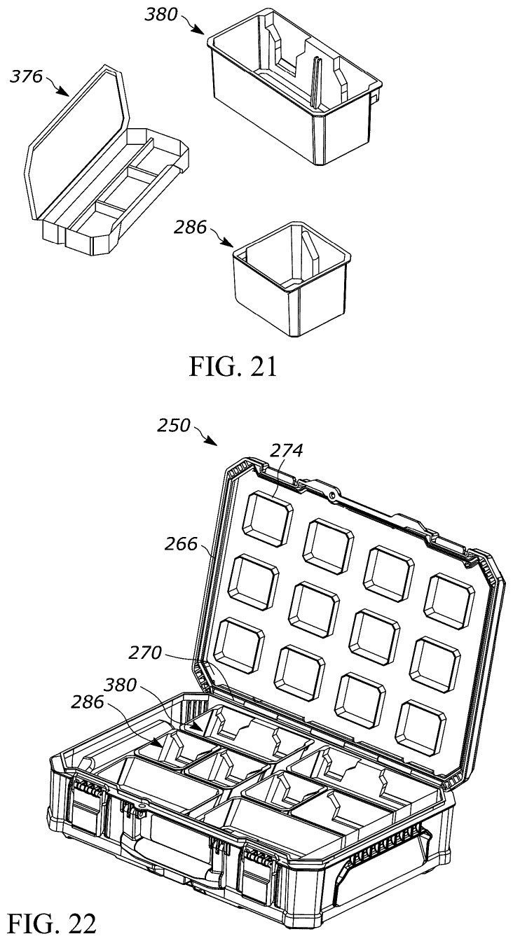

FIGS. 20-21 illustrate additional arrangements of the containers 300, 250. In FIG. 20, the container 300 is illustrated without any bins 286. FIG. 21 illustrates the bin 286, a bin 380 which is generally dimensioned with twice the length as the bin 286, and a small parts organizer 376. FIG. 22 illustrates the container 250 with the protrusions 274 and housing a plurality of the bins 286, 380 therein. The bin 380 and the small parts organizer 376 may be provided with cleat interfaces 288 similar to the bin 286. The small parts organizer 376 may include a hinged lid which can be closed.

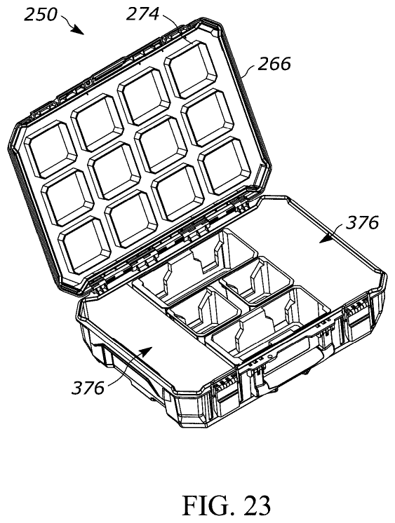

FIG. 23 illustrates the small parts organizer 376 provided within the container 250. FIG. 24 illustrates the bin 286, the bins 380, and the small parts organizer 376 mounted upon a wall panel 375 and a rail 384. The wall panel 375 and the rail 384 each include cleats 144 which are spaced from each other. The rail 384 engages the wall panel 375 at an interface 388. The interface may include a male-female connection in which the wall panel 375 is mated to the rail 384 such that the cleats 144 of the wall panel 375 and the rail 384 are evenly spaced from each other such that the cleat interface 288 of the bin 388 may span both the wall panel 375 and the rail 386.

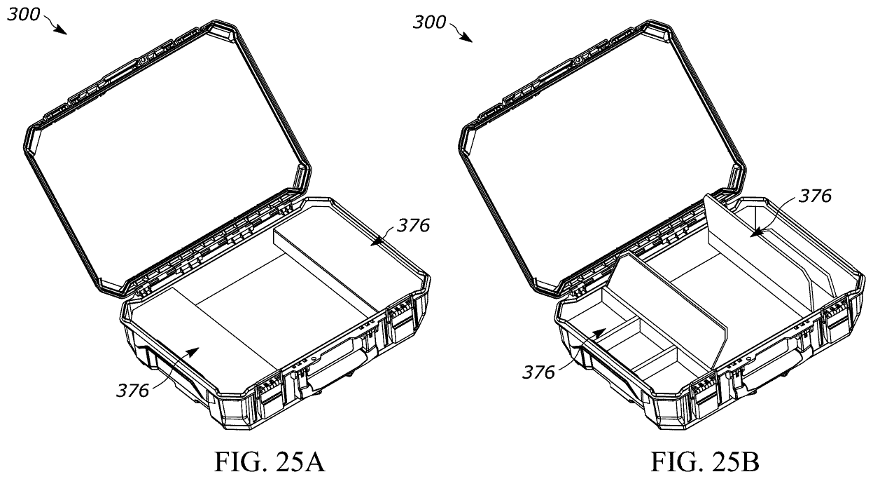

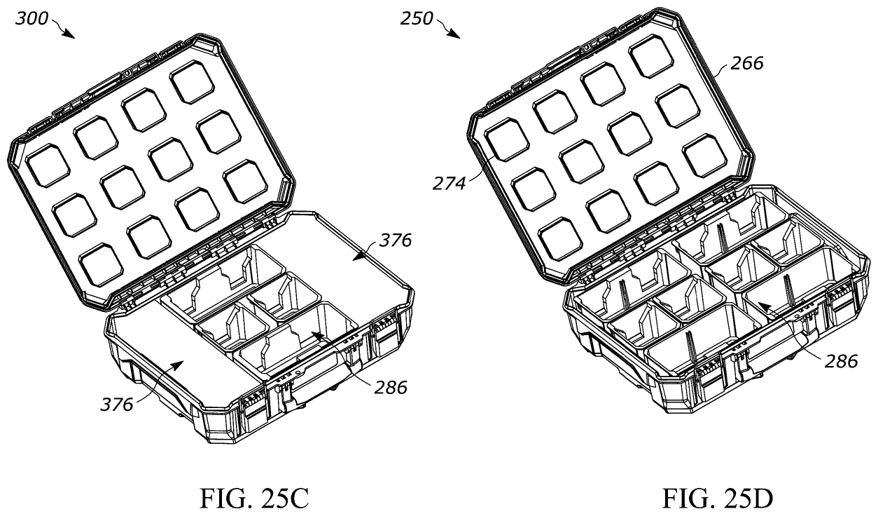

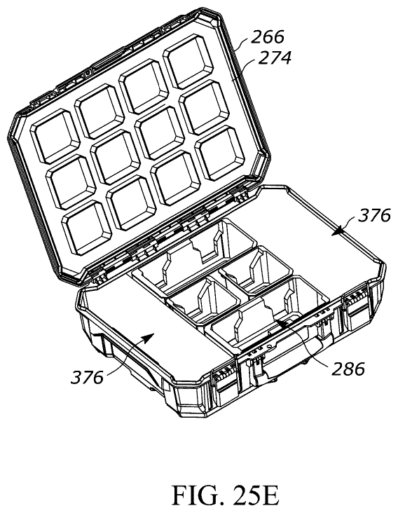

FIGS. 25A-25E illustrate alternate embodiments of the bins 286, 380 and the small parts organizer 376 as provided within the containers 250, 300.

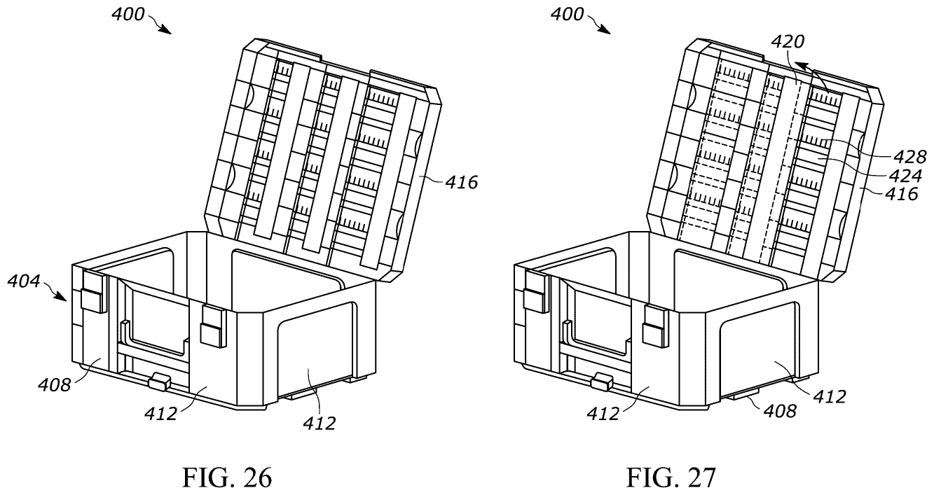

FIGS. 26-27 illustrate another container 400. The container 400 is provided with like features to the container 104 with reference numbers in the “400” series. However, the container 400 is provided with the lid 416 having a hinged door 420 which reveals at least one bit holder 424. The bit holder 424 is configured to receive a plurality of bits 428 therein.

The embodiments described above with respect to FIGS. 16A-27, a hierarchy of storage containers is provided. First, the rolling toolbox 100 may include a plurality of containers (e.g., the containers 104, 300, 304, 250, 400). At least one of the containers 104, 300, 304, 250, 400 includes a wheel 132 for rolling the rolling toolbox 100 between the storage location and the work space. Second, each of the containers 104, 300, 304, 250, 400 may be provided with at least one bin therein. In the embodiments illustrated above, the bin may be, for example, the bins 286, 308, 320, 330, 348, 380, the elastic band structure 312, the small parts organizer 376, and the lid 416 function as a bin to retain an item to and/or within at least one of the containers 104, 300, 304, 250, 400. In the case of the lid 416, as described above, the bit holder 424 is provided on the lid 416 with the lid 416 and door 420 functioning as a bin. Each of the bins may be reconfigured or otherwise dimensioned to engage any of the described bins. The hierarchy may be extended further to include other bins smaller than the described bins, and/or other tool storage systems other than the rolling toolbox 100 (e.g., the wall panel 375, rail 384).

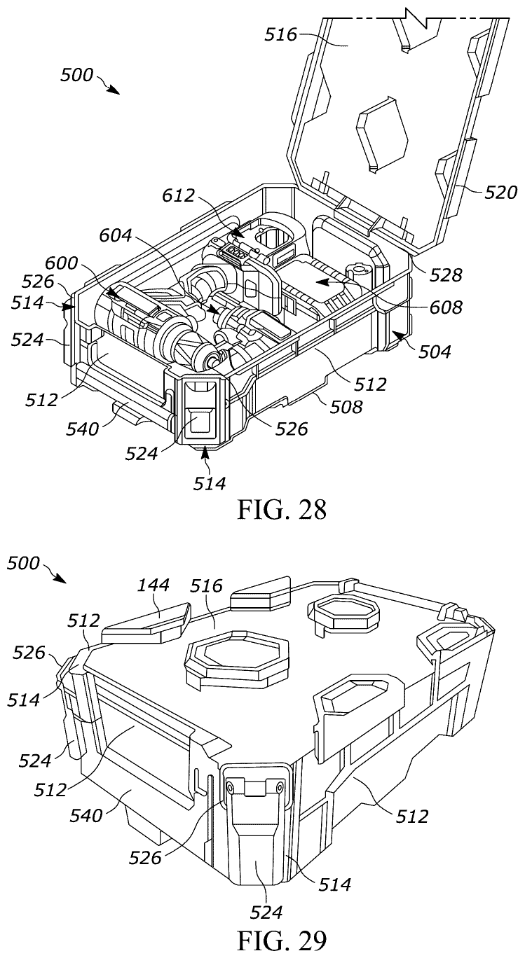

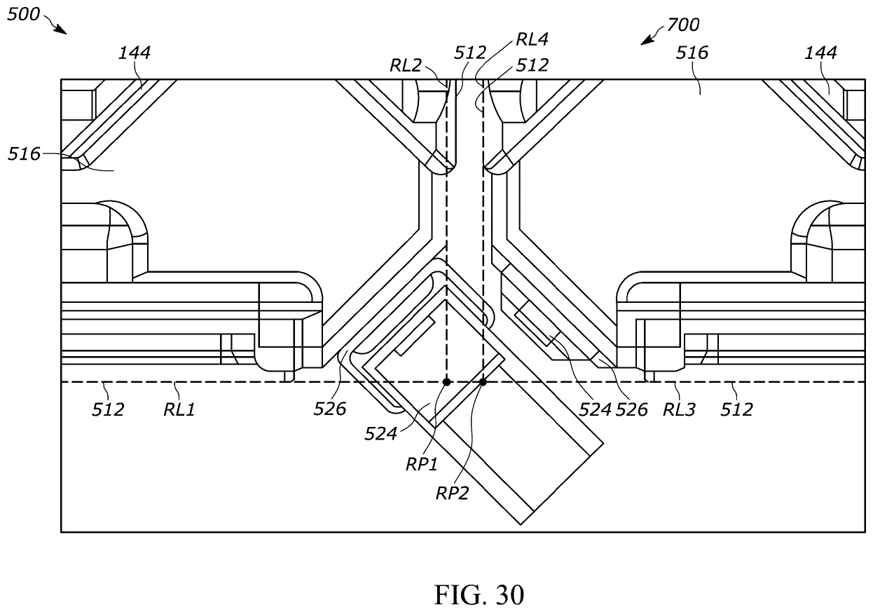

FIGS. 28-30 illustrate a container 500 which is generally dimensioned with half the width as the containers 104, 300, 304. Accordingly, in the rolling toolbox 100 (FIG. 1), the container 500 and another similarly dimensioned container 500 can be supported side-by-side by one other of the containers 104, 300, 304. The container 500 includes a base 508 and a plurality of sidewalls 512 extending from the base 508. A base 508 of the container 500 and a base 500 of an adjacent container 700 of similar geometry to the container 500 (FIG. 30) may be dimensioned to engage one of the containers 104, 300, 304. Accordingly, the bases 508 of the containers 500, 700 are dimensioned with a “combined base” configured to engage one of the other containers 104, 300, 304 which supports both the container 500 and the container 700. Each sidewall is in contact with an adjacent sidewall 512 at a corner 514. The container 500 includes a lid 516 hingedly coupled to one of the sidewalls 512 by a hinge coupling 528. A latch 524 is coupled to the corner 514 opposite the hinge coupling 528 between the lid 516 and the sidewall 512. The corner 514 is generally planar and transverse to both the sidewall 512 and the adjacent sidewall 512. In the illustrated embodiment, the corner 514 extends generally perpendicularly from the base 508 at a 45 degree angle with respect to each of the sidewalls 512 (the angle being measured from an exterior surface of the sidewall 512 to an exterior surface of the corner 514). However, other angles are possible. The latch 524 is movable between an engaged position in which the latch 524 secures the lid 516 to the corner 514 and a disengaged position in which the lid 516 is movable relative to the sidewall 512.

The container 500 can secure a plurality of items therein. In the illustrated embodiment of FIG. 28, the bin 500 holds a drill 600, an impact driver 604, a battery pack 608, and a battery charger 612 therein. However, other items may be held within the container 500.

FIG. 29 further illustrates the exterior of the container 500. The lid 516 is provided with cleats 144. The latch 524 is provided with a draw arm 526 which is movable relative to the latch 524. FIG. 29 illustrates the latch 524 and the draw arm 526 in a locked position in which the draw arm 526 pulls against the lid 516 to secure the lid to the corner 514. The draw arm 526 is pivotally coupled to the latch 524 such that, in the engaged position, the draw arm 526 pulls the lid 516 towards the corner 514, and in the disengaged position, the draw arm 526 is removed from the lid 516 to permit hinged pivoting of the lid 516 relative to the sidewalls 512. The container 500 may be provided with a handle 540 between the corners 514 having latches 524.

FIG. 30 illustrates use of the container 500 with an adjacent container 500 (illustrated as container 700). The location of the latches 524 on the corners 514 permits use of at least one of the latches 524 even while the container 500 and the adjacent container 500 are mounted side-by-side upon another container 104, 300, 304. As illustrated in FIG. 30, the sidewall 512 extends along a reference line RL1, and an adjacent sidewall 512 extends along a reference line RL2. The reference lines RL1, RL2 converge at a reference point RP1. The reference lines RL1, RL2 define a hypothetical boundary defining the extent of the sidewalls 512 of the container 500. Similarly, the adjacent container 700 includes the sidewall 512 which extends along a reference line RL3, and an adjacent sidewall 512 which extends along a reference line RL4. The reference lines RL3, RL4 converge at a reference point RP2. The reference lines RL3, RL4 define a hypothetical boundary defining the extent of the sidewalls 512 of the container 700. A gap is located between the reference points RP1, RP2 such that the sidewalls defined by the reference lines RL2, RL4 do not intersect.

The container 500 is illustrated with the latch 524 in a disengaged (i.e., open or at least partially open) position in which the latch 524 is moved (i.e., pivoted) away from the corner 514. When the latch 524 is in the engaged position (i.e., the latch 524 of the container 700), the latch 524 is located entirely within a hypothetical boundary extended between the reference lines RL3, RL4 of the sidewalls 512 of the container 700. Similarly, the draw arm 526 may be removed from its position above the lid 516, and the latch 524 may be positioned entirely within the reference lines RL3, RL4 of the sidewalls 512 of the container 700 with the latch 524 in the disengaged position. However, when the latch 524 is in the disengaged position (i.e., the latch 524 of the container 500) in which the latch 524 is pivoted away from the corner 514, the latch 524 is located partially within the reference lines RL1, RL2 as well as being partially located within a hypothetical boundary extended from the reference lines RL3, RL4 of the container 700. However, while the latch 524 of the container 500 is moved between the engaged position and the disengaged position, the latch 524 of the adjacent container 700, while locked to the lid 516, does not interfere with the latch 524 of the container 500. As such, at least one of the adjacent latches 524 of the adjacent containers 500, 700 may be movable between the engaged and the disengaged positions while the adjacent containers 500, 700 are positioned side-by-side with respect to one another.

Referring now to FIGS. 31A-31B, a mating interface 818 is configured to secure a base 822 of one container (e.g., the container 300) to a lid 826 of an underlying container (e.g., the container 104). The mating interface 818 is movable between an engaged position (i.e., a “first position”, FIG. 31A) in which the containers 104, 300 are coupled to each other and a disengaged position (i.e., a “second position,” FIG. 31B) in which the containers 104 are movable relative to each other. FIGS. 31A-31B illustrate that the base 822 of the container 300 is provided with a ramped surface 850, and the lid 826 includes a flange or tab 846. The tab 846 may be provided on the cleat 144 (FIG. 1). The mating interface 818 may include a locking member 890 which is movable. In some embodiments, the locking member 890 may be biased towards the engaged position. In another embodiments, the locking member 890 may be otherwise arranged between the containers 104, 300.

During a stacking operation of adjacent containers 104, 300, one container (e.g., the container 300) is placed on top of another container (e.g., the container 104) such that the adjacent containers 104, 300 engage one another at the mating interface 818 and are commonly oriented (FIG. 1). A force exerted along the stacking direction D1 (e.g., by the user, or due to the weight of the upper container 300, and/or both) may cause the ramped surfaces 850 of projections 842 to align the base 822 on the lid 826 with the ramped surface 850 positioned adjacent the tab 846. The force along the stacking direction D1 may also move the locking member 890 against the biasing force toward the second position (FIG. 31B). Once the adjacent containers 104, 300 are brought close enough together for the locking member 890 to move past the tab 846 and inclined surface 850, the locking member 890 is urged to at least partially extend into a gap 862 located between the ramped surface 850 and a surface 834 of the lid 826 (i.e., to a “first position”, FIG. 31A). In this position, the locking plate 890 is retained between the tab 846 and the surface 834, and the locking plate 890 inhibits movement of the base 822 relative to the lid 826 in a direction at least partially parallel to the stacking direction D1. Additionally, in this position, the locking plate 890 engages portions of both containers 104, 300 thereby locking the containers 104, 300 together.

During a separating operation of adjacent containers 814, the user actuates a button 892. The button 892 may be integrally formed with the locking plate 890 such that translation of the button 892 (from the first position in FIG. 31A to the second position of FIG. 31B) causes corresponding translation of the locking plate 890. In the illustrated embodiment, the button 892 may be translated in a direction generally perpendicular to the stacking direction D1. Other actuation directions may be possible. In some embodiments, the button 892 is positioned to enable the locking member 890 to be moved by the same hand that grasps the handle 140 (FIG. 1). Once the storage containers 814 are released from one another, the adjacent containers 814 may be separated along the stacking direction D1 (e.g., by lifting an upper container away from a lower container). After the containers 814 have been separated, the locking member 890 may move to the first position by way of the biasing force. Other similar mating interfaces 818 my interconnect the container 104 to the container 300.

Although the disclosure has been described in detail with reference to certain embodiments, variations and modifications exist within the scope and spirit of one or more independent aspects as described. Various features and advantages are set forth in the following claims.

1-30. (canceled)

31. A rolling toolbox comprising:
a container including a base, a plurality of sidewalls at least partially defining an outer wall of an interior compartment, a lid coupled to one of the sidewalls, and a latch, the lid movable between a closed portion and an open position, the interior compartment being accessible while the lid is in the open position, the interior compartment being covered while the lid is in the closed position, the latch selectively securing the lid in the closed position, the lid including a feature configured to engage a complementary feature positioned on the base of another container and releasably secured to the other container in a stacked relationship;
the container including at least a first connection feature configured to engage a mating feature of a bin, divider, small parts organizer received within the interior compartment;
a wheel rotatably coupled to the container and supporting the container for movement on a support surface; and
a handle coupled to the container to guide movement of the container, the handle being movable between a retracted position and an extended position.

32. The toolbox of claim 31, further comprising a lock device for selectively securing the handle in at least one of a retracted position and the extended position.

33. The toolbox of claim 32, wherein the lock device includes, a pivot pin, a locking pin receiving the pivot pin, and an actuator coupled to the pivot pin, the locking pin movable in response to movement of the actuator, the actuator movable between a locked position in which the locking pin is secured to a mating element on the handle and a released position in which the locking pin is removed from the mating element.

34. The toolbox of claim 31, wherein the first connection feature includes at least one recess, wherein the mating feature is a foot or a hook configured to engage the recess.

35. The toolbox of claim 31, wherein the first connection feature is positioned on a peripheral edge of at least one of the sidewalls, wherein the mating feature is a hook configured to selectively engage the first connection feature.

36. The toolbox of claim 35, wherein the hook can selectively engage the first connection feature in one of a first orientation and a second orientation.

37. The toolbox of claim 31, wherein an interior surface of the lid includes protrusions configured to substantially engage an upper edge of the bin, divider, or small parts organizer positioned within the interior compartment while the lid is in the closed position.

38. The toolbox of claim 31, wherein the first connection feature comprises an upper portion of at least one of the plurality of sidewalls.

39. The toolbox of claim 31, further comprising a second connection feature configured to engage a mating feature of an accessory with at least a portion of the accessory positioned outside of the interior compartment.

40. The toolbox of claim 39, wherein the mating feature of the accessory comprises a hook.

41. The toolbox of claim 31, the feature comprising a tab.

42. A storage container assembly comprising:
a first container including a base, at least one sidewall extending from the base and at least partially defining an outer wall of an interior compartment of the first container, and a lid of the first container coupled to the sidewall and movable between an open position and a closed position, the interior compartment being accessible while the lid is in the open position, the interior compartment being covered while the lid is in the closed position, the first container including a first connection feature, and a wheel supporting the first container for movement on a support surface;
a second container including a base, a plurality of sidewalls extending from the base and defining an outer wall of an interior compartment of the second container, a lid of the second container coupled to the sidewalls and movable between an open position and a closed position, the base of the second container including a feature configured to engage a complementary feature positioned on the lid of the first container and releasably secured to the first container in a stacked relationship; and
a storage bin including a compartment and a mating feature, the storage bin being selectively mountable in a configuration in which the mating feature engages the first connection feature.

43. The storage container assembly of claim 42, wherein at least one of the first container and the second container includes a locking member that is slidable between an engaged position in which the locking member secures the base of the second container to the lid of the first container and a disengaged position in which the second container is removable from the lid of the first container.

44. The storage container assembly of claim 42, further comprising a handle coupled to the container to guide movement of the container, the handle being movable between a retracted position and an extended position.

45. The storage container assembly of claim 42, wherein the second container further comprises the first connection feature, the storage bin being selectively mountable with the second container.

46. The storage container assembly of claim 42, the complementary feature positioned on the lid of the first container comprising a tab.

47. The storage container assembly of claim 46, the feature of the base of the second container comprising a ramped surface, the ramped surface configured to align the base of the second container on the lid of the first container with the ramped surface positioned adjacent the tab.

48. The storage container assembly of claim 42 comprising a mating interface configured to secure the base of the second container to the lid of the first container, the mating interface comprising a locking member movable between an engaged position and a disengaged position.

49. The storage container assembly of claim 48, the second container comprising a button configured to move the locking member into the disengaged position to enable separation of the first container and the second container from a stacked configuration.

50. The storage container assembly of claim 42, wherein the first connection feature comprises an upper portion of at least one of the plurality of sidewalls of the first container.
